(19) United States
(12) Patent Application Publication
(10) Pub. No.: US 2007/0174885 A1
(43) Pub. Date: Jul. 26, 2007

(54) Multicast transmission method, system and communication station

(75) Inventors: Olivier J-M. Hus, Redhill (GB); Matthew P.J. Baker, Canterbury (GB); Paul Bucknell, Brighton (GB); Timothy J. Moulsley, Caterham (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/589,108

(22) PCT Filed: Feb. 8, 2005
(86) PCT No.: PCT/IB05/50491

§ 371 Date: Aug. 10, 2006

(30) Foreign Application Priority Data
Feb. 12, 2004 (GB) 0403128.2

(51) Int. Cl. H04N 7/173

(52) U.S. Cl. 725/105; 348/E07.056; 725/102; 725/100; 725/131

(57) ABSTRACT

In a multicast transmission system, the transmission of data is acknowledged by each receiving station to indicate whether or not a retransmission is required. For the retransmission, a transmitting station can select between a broadcast mode in which the retransmission is not addressed to a specific recipient, or a dedicated mode in which the retransmission is addressed to a specific recipient. The selection may be based on the number of receiving stations requiring a retransmission.

The invention relates to a method of multicast transmission, to a system for multicast transmission, and to communication stations for use in a multicast transmission system.

A Multimedia Broadcast Multicast Service (MBMS) is being introduced to the Universal Mobile Telecommunication System (UMTS) which will enable the reliable transmission of shared data to a potentially very large number of recipients. In adverse radio channel conditions, it may be necessary to apply a retransmission scheme triggered by some feedback mechanism from the receivers, in order to reduce data loss and increase the performance.

Retransmission schemes for the reliable delivery of data in multicast systems, also known as point-to-multipoint systems, are known. Such schemes usually imply the use of some form of feedback mechanism between the receivers, known in UMTS terminology as User Equipments (UEs), and the network, known in UMTS terminology as NodeB, enabling MBMS UEs to request retransmission of failed packets from an MBMS session.

A UE could indicate that it needs a retransmission or wants to fetch some missing data following erroneous reception, using some form of feedback signalling in an uplink physical channel between the UE and the NodeB to carry “on-demand” retransmission requests, for example taking the form of a positive acknowledgment (ACK) when the UE receives a multicast packet correctly, indicating no need to retransmit, or a negative acknowledgement (NACK) when the UE detects some packet error or loss, indicating a need or a request to retransmit that piece of data. In a multicast system a large amount of feedback signalling can be generated when the number of recipients is large.

Possible existing uplink channels in UMTS, that is in the direction UE to NodeB, which could be reused for the feedback include Dedicated Channels (DCH) and the Random Access Channel (RACH).

The existing RACH is divided in a time-division manner into sets of Access Slots. Each set of Access Slots can be assigned to transmissions of a given priority level, known as an Access Service Class (ASC). Within each set of access slots, the UE chooses a random access slot and transmits a preamble using a randomly-selected signature to minimise the probability of collisions occurring due to different UEs choosing the same access slot and signature.

Alternatively, the DCH transport channel in UMTS could be used to carry feedback signalling in the uplink physical channel for implementing point-to-point retransmission through dedicated feedback signalling . However, this would give rise to a huge increase in uplink traffic due to feedback signalling when many individual UEs need retransmissions, some of the feedback signalling would be redundant when a number of UEs need and ask for retransmission of the same data, and significant delay may occur while a DCH is set up.

An objective of the invention is to provide improved multicast transmission.

According to a first aspect of the invention there is provided a method of operating a multicast transmission system comprising a first station and a plurality of second stations, the method comprising
at the first station, transmitting data;
at each of the second stations:

receiving the data;

determining whether the received data is fully decodable;

if the data is not fully decodable, transmitting a reply signal; and
at the first station:

receiving the reply signal from at least one of the second stations, and

in response to receiving the reply signal, retransmitting at least a portion of the data;
further comprising
the reply signal being devoid of an indication of the identity of the transmitting second station;
at the first station:

selecting, for retransmitting the data, between a dedicated mode in which the data is addressed to one of the second stations and a broadcast mode in which the data is broadcast to a plurality of the second stations;

in response to selecting the dedicated mode and prior to the retransmission, transmitting a further signal;
at each of the second stations which transmitted the reply signal, in response to receiving the further signal, transmitting an indication of its identity; and
at the first station, receiving the indication of identity and employing the indication of identity to address the retransmission to one of the second stations.

According to a second aspect of the invention there is provided a communication station for use in a multicast transmission system comprising a plurality of second stations, the communication station comprising:
means for transmitting data;
means for receiving a reply signal from at least one of the second stations, and
means responsive to receiving the reply signal for retransmitting at least a portion of the data;
further comprising
means for selecting, for retransmitting the data, between a dedicated mode in which the data is addressed to one of the second stations and a broadcast mode in which the data is broadcast to a plurality of the second stations;
means responsive to selecting the dedicated mode for transmitting a further signal;
means for receiving an indication of identity transmitted by a second station; and
means for employing the indication of identity to address the retransmission to one of the second stations.

According to a third aspect of the invention there is provided a communication station for use in a multicast transmission system, the communication station comprising:
means for receiving data;
means for determining whether the received data is fully decodable; and
means responsive to the data not being fully decodable for transmitting a reply signal devoid of an indication of identity of the communication station; and
means responsive to receiving a further signal for transmitting an indication of identity of the communication station;
means for receiving a retransmission of at least a portion of the data whether addressed to the communication station or whether broadcast.

The invention uses a random access channel for feedback signalling. According to the invention, a retransmission request message transmitted by a second station, which may be a UE, consists of two parts, the first part specifying the unit of data to be retransmitted, and the second part comprising an identification (ID) of the second station. Other information may also be included in either part of the message. An important aspect of the invention is that the transmission of the second, identification part is dependent on the type of response received from the first station, which may be a NodeB, to the first part of the retransmission request.

The initial transmission of data is in a broadcast mode, also known as a multicast mode, and on receipt of a retransmission request the first station makes a decision as to whether the retransmitted data should be transmitted in broadcast mode or dedicated mode, and determines accordingly what type of acknowledgement signal, to transmit in response to the retransmission requests. If the first station decides to use a broadcast mode to retransmit the requested data unit, it may transmit a first signal to the second stations which requested retransmission of that data unit to prevent those second stations from transmitting their IDs. Alternatively, if the first station decides to retransmit using dedicated channels, it transmits a second signal instructing those second stations to continue with the second part of their transmission including their ID. Note that different approaches could be used for different groups of secondary stations in a cell.

The decision between broadcast and dedicated modes, and hence between the first and second signals, may be based on an estimate of the number of second stations requesting retransmission of a particular data unit.

Optionally, if the broadcast mode is selected for the retransmission, transmission of the first signal may be omitted, with the first station proceeding directly with the retransmission.

Some advantages of the invention are:
Efficiency of retransmissions is improved.
If a large number of second stations are requesting retransmission of one particular data packet, a high combined uplink power will be received, in the relevant access slot with the relevant signature if different access slots and signatures are used to indicate different data packets, enabling, in the case of UMTS, the Node B to terminate the RACH preamble power ramping quickly by transmission of the corresponding Acquisition Indicator Channel (AICH) message.
Uplink interference is minimised by avoiding transmission on the random access channel of the identification part of the message when large numbers of second stations require the same retransmission, when it is more efficient to use broadcast mode for the retransmission. In this case identification of the second station and of the exact number of second stations requiring the retransmission are not required.
The invention allows the first station to select broadcast or dedicated modes for retransmissions in a manner appropriate to the situation.

The invention will now be described, by way of example only, with reference to the accompanying drawings in which:

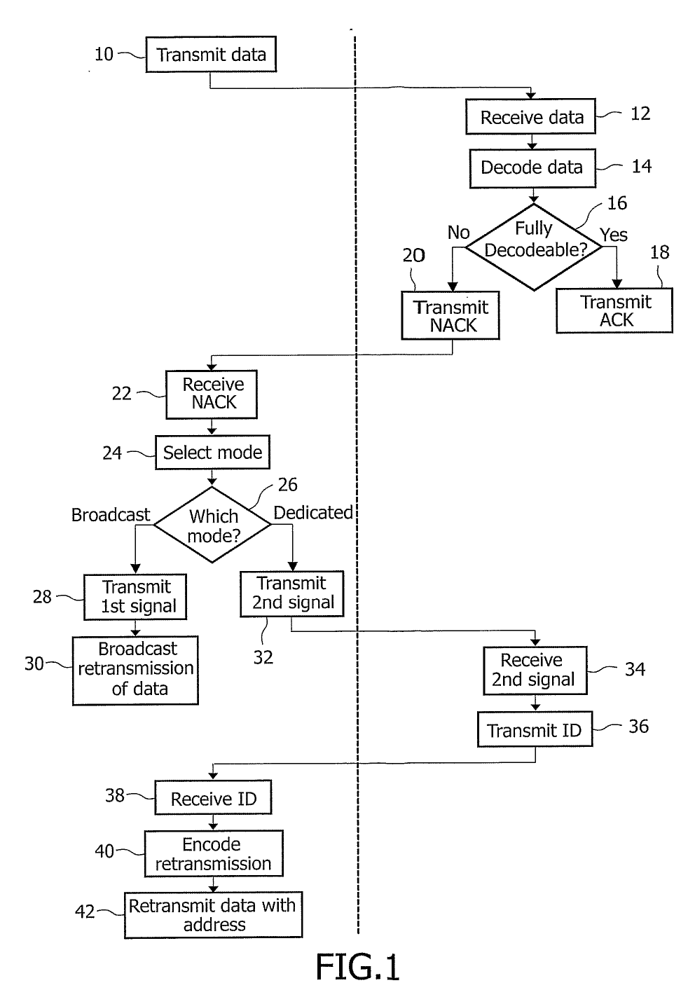

FIG. 1 is a flow chart of a method of operating a multicast system in accordance with the invention; and

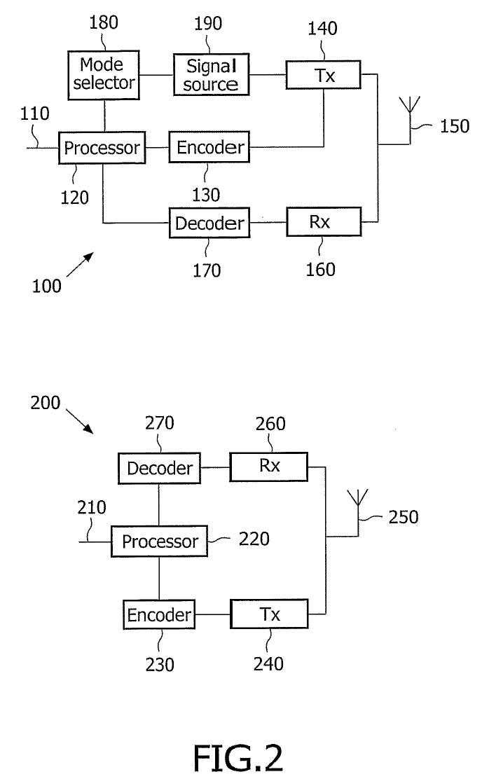

FIG. 2 is a block schematic diagram of a multicast system comprising a first station 100 and a second station 200.

Referring to FIG. 1, the method steps on the left side of the drawing relate to steps performed by a first station 100, which in the context of UMTS would be a NodeB base station, and the method steps on the right side of the drawing relate to steps performed by each of a plurality of second stations 200, which in the context of UMTS would be UEs.

The method commences at step 10 with the transmission of data from a first station 100. This initial transmission is in a broadcast mode in which individual recipients are not addressed in the transmission. At step 12 the data is received by a number of second stations 200, and decoded at step 14.

At step 16 each second station 200 determines whether the data is fully decodable, according to a predetermined criterion. This decision may take account of portions of the data transmitted previously. In some applications, the data may be regarded as fully decodable despite some residual errors, if the residual errors are tolerable. If the data is regarded as fully decodable a positive acknowledgement ACK is transmitted at step 18 to indicate that no retransmission is required by that second station 200. If the data is regarded as not fully decodable, a negative acknowledgement NACK is transmitted at step 20 to indicate that retransmission is required by that second station 200. The NACK may indicate one or more portions of the data for which a retransmission is required.

If all of the second stations 200 transmit an ACK, and these acknowledgements are received by the first station 100, no retransmission is required and so the first station 100 may proceed to transmit more data at step 10, or terminate the process if there is no more data to be transmitted.

At step 22 any negative acknowledgements NACK are received by the first station 100.

At step 24 the first station 100 determines whether the retransmission should be transmitted in a broadcast mode, in which individual recipients are not addressed in the retransmission, or in a dedicated mode, in which an individual recipient is addressed in the retransmission. The decision between broadcast and dedicated modes may be based on an estimate of the number of second stations 200 requesting retransmission of a particular data unit. For example, the estimate of the number of second stations 200 may be derived from an estimate of the amount of received signal energy corresponding to the received negative acknowledgements, or from the number of autocorrelation peaks detected for that signal.

At step 26, alternative actions are selected according to which mode was selected at step 24. If a broadcast mode is selected, then at step 30 the retransmission is made comprising a portion or the whole of the data. Prior to the retransmission, at step 28 a signal, referred to in FIG. 1 as a first signal, may be transmitted which prevents the requesting second stations 200 from transmitting their identification. Alternatively, the first station may omit the transmission of the first signal and proceed with the retransmission. After the retransmission at step 30, flow proceeds from step 12 again.

If a dedicated mode is selected, then at step 32 the first station 100 transmits another signal, referred to in FIG. 1 as a second signal, instructing the requesting second stations 200 to transmit their identifications (IDs).

Optionally the first and second signals may be acknowledgements. The first signal may be a negative acknowledgement and the second signal may be a positive acknowledgement, or alternatively the first signal may be a positive acknowledgement and the second signal may be a negative acknowledgement.

At step 34 the requesting second stations 200 receive the second signal and at step 36 transmit their IDs.

At step 38 the IDs are received by the first station 100 and at step 40 the first station encodes the data for retransmission, using an ID to address the retransmission to an individual second station 200. At step 42 the encoded data is retransmitted. Thereafter, a conventional retransmission protocol may be used to ensure delivery of the data to the individual second station 200. Subsequently steps 40 and 42 are repeated for the other second stations that have identified themselves.

Referring to FIG. 2, the first station 100, which in the case of UMTS may be a NodeB, comprises a processing means 120 for receiving data on an input 110. An encoder 130 is coupled to the processing means 120 for encoding the data, either the initial data or the retransmission of the whole data, or portion of the data. The encoder is also coupled to a transmitter 140 for transmitting the encoded data. The transmitter 140 is coupled to an antenna 150.

Also coupled to the antenna 150 is a receiver 160 for receiving reply signals (ACK and NACK) transmitted by the second stations 200. A decoder 170 is coupled to the receiver 160 for decoding the received reply signals, and is coupled to the processor 120 for supplying the decoded reply signals to the processor 120.

A mode selector 180 is coupled to the processor 120 for determining, based on the acknowledgements received in reply to the transmission of data, whether a retransmission of data should use a broadcast mode or dedicated mode.

Coupled to the mode selector 180 is a signal source which generates either the first or second signal, depending on which mode is selected for the retransmission, as described above with reference to FIG. 1. The signal source is coupled to the transmitter 140 for transmission of the first or second signal.

If the second signal is transmitted in response to the acknowledgements received from the second stations 200, the IDs transmitted by the second stations are received by the receiver 160, decoded by the decoder 170, and transferred to the processor 120. The encoder 130 is adapted to encode retransmissions using an ID of a second station 200 to address the retransmission to that individual second station 200 in the case that the mode selector 180 has selected the dedicated mode, or to encode retransmissions without addressing an individual second station 200 in the case that the mode selector 180 has selected the broadcast mode.

Referring further to FIG. 2, the second station 200, which in the case of UMTS may be a UE, comprises a receiver 260 coupled to an antenna 250 for receiving signals from the first station 100, and a decoder 270 coupled to the receiver 260 to decode the received signals. There is a processor 220 coupled to the decoder 270 to receive the decoded signals. When data is received and decoded, if the data is fully decodable, the processor 220 delivers the data on an output 210 and generates a positive acknowledgement for transmission, and if the data is not fully decodable, the processor 220 generates a negative acknowledgement requesting retransmission of all, or a portion of, the data. An encoder 230 is coupled to the processor 120 for encoding the reply acknowledgement, and is coupled to a transmitter 240 for transmission of the reply via the antenna 250.

In response to the receipt of either the first or second signals from the first station 100, as described above, the processor 220 determines whether to generate an identification signal for transmission, in the case that the second signal is received as a result of the first station 100 selecting the dedicated mode for a retransmission, or refrain from generating an identification signal in the case that the first signal is received as a result of the first station 100 selecting the broadcast mode.

The following four paragraphs describe how the invention may be applied to UMTS.

Optionally, the UE may format the reply acknowledgement according to the following rules, which are designed to cause requests from different UEs for retransmission of the same data unit to collide, in contrast to the normal UMTS RACH procedure which uses random functions to minimise the risk of collision. Certain RACH access slots are designated specifically for MBMS use. This can be done for example by:
defining a new Access Service Class specifically for MBMS feedback signalling, where the new Access Service Class would not be used by second stations 200 which are not MBMS-capable), or
defining a specific set of access slots as being reserved for MBMS feedback signalling; these access slots would not then be able to be allocated by the Radio Network Controller (RNC) for any of the non-MBMS ASCs.

The first of these methods gives greater flexibility to the network in configuring the access slots. Within the defined access slots, specific combinations of access slot and/or signature may be used to indicate which packet(s) should be retransmitted.

The behaviour of a UE on receipt of the first or second signal, such as a positive or negative acknowledgement, from a NodeB may be modified compared to the normal UMTS RACH procedure. Two possibilities are:

a) If the UE receives a positive acknowledgement, it transmits the message part containing its ID, thereby enabling the NodeB to transmit the retransmission in dedicated mode. If the UE receives a negative acknowledgement, or no acknowledgement, it shall not transmit the message part containing its ID, and expects the retransmission to be broadcast.

b) If the UE receives a positive acknowledgement, it does not transmit the message part containing its ID, in contrast to the normal RACH procedure where receipt of a positive acknowledgement is the indication that the message part should be transmitted. In this case, the UE would expect the retransmission to be broadcast. If the UE receives a negative acknowledgement, it does not transmit the message part containing its ID and further it shall not transmit another RACH preamble using the access slot and signature corresponding to the same data unit, but should switch to a different ASC and transmit a conventional RACH message including the ID message part. In this case, the retransmission could be transmitted in dedicated mode after the conventional RACH message has been received by the Node B.

In an embodiment of the invention, specific RACH access slots or groups of access slots can be allocated for MBMS feedback signalling for specific MBMS services or sessions.

In one embodiment of the invention specific UEs are allocated to specific RACH access slots or groups of access slots according to the quality of reception of UEs, separating UEs into groups according to quality metrics such as:
E_{b}/N₀ over a predetermined time period
the number or proportion of packets previously received successfully in a predetermined time window.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art of multicast communication and which may be used instead of or in addition to features already described herein.

1. A method of operating a multicast transmission system comprising a first station and a plurality of second stations, the method comprising
at the first station, transmitting data;
at each of the second stations:
receiving the data;
determining whether the received data is fully decodable;
if the data is not fully decodable, transmitting a reply signal; and
at the first station:
receiving the reply signal from at least one of the second stations, and
in response to receiving the reply signal, retransmitting at least a portion of the data;
further comprising
the reply signal being devoid of an indication of the identity of the transmitting second station;
at the first station:
selecting, for retransmitting the data, between a dedicated mode in which the data is addressed to one of the second stations and a broadcast mode in which the data is broadcast to a plurality of the second stations;
in response to selecting the dedicated mode and prior to the retransmission, transmitting a further signal;
at each of the second stations which transmitted the reply signal, in response to receiving the further signal, transmitting an indication of its identity; and
at the first station, receiving the indication of identity and employing the indication of identity to address the retransmission to one of the second stations.

2. A method as claimed in claim 1, further comprising estimating the number of second stations transmitting the reply signal and selecting the mode dependent on the estimate.

3. A method as claimed in claim 1, wherein the reply signal is transmitted in an access slot indicative of a portion of data to be retransmitted.

4. A method as claimed in claim 1, wherein the reply signal comprises a signature indicative of a portion of data to be retransmitted.

5. A method as claimed in claim 1, wherein the further signal comprises a positive acknowledgement.

6. A method as claimed in claim 1, wherein the transmitted indication of identity comprises a message transmitted on a random access channel having an access service class (ASC) different from the ASC of the reply signal.

7. A communication station for use in a multicast transmission system comprising a plurality of second stations, the communication station comprising:
means for transmitting data;
means for receiving a reply signal from at least one of the second stations, and
means responsive to receiving the reply signal for retransmitting at least a portion of the data;
further comprising
means for selecting, for retransmitting the data, between a dedicated mode in which the data is addressed to one of the second stations and a broadcast mode in which the data is broadcast to a plurality of the second stations;
means responsive to selecting the dedicated mode for transmitting a further signal;
means for receiving an indication of identity transmitted by a second station; and
means for employing the indication of identity to address the retransmission to one of the second stations.

8. A communication station as claimed in claim 7, wherein the means for selecting the mode is adapted to estimate the number of second stations transmitting the reply signal and to select the mode dependent on the estimate.

9. A communication station for use in a multicast transmission system, the communication station comprising:
means for receiving data;
means for determining whether the received data is fully decodable; and
means responsive to the data not being fully decodable for transmitting a reply signal devoid of an indication of identity of the communication station; and
means responsive to receiving a further signal for transmitting an indication of identity of the communication station;
means for receiving a retransmission of at least a portion of the data whether addressed to the communication station or whether broadcast.

10. A communication station as claimed in claim 9, wherein the means for transmitting the reply signal is adapted to indicate a portion of the data for which retransmission is requested by selection from a plurality of at least one of a time slot and a signature.

11. A multicast transmission system comprising a first station in accordance with claim 7 and a plurality of second stations.
